(19) United States
(12) Patent Application Publication
(10) Pub. No.: US 2013/0306255 A1
(43) Pub. Date: Nov. 21, 2013

(54) Roller Tube Having Fabric Attachment Channel

(71) Applicant: Philip Ng, Thornhill (CA)

(72) Inventor: Philip Ng, Thornhill (CA)

(21) Appl. No.: 13/473,857

(22) Filed: May 17, 2012

(51) Int. Cl. E06B 9/44; B23P 17/04

(52) U.S. Cl. 160/368.1; 29/428

(57) ABSTRACT

There is disclosed an improved roller tube having a tubular wall, opposite ends and a channel running longitudinally on the surface of the tubular wall for receiving an attachment insert for a fabric sheet. The attachment insert includes an elongated flat member having opposite ends, opposite sides, a thickness, opposite side edges and a width. The channel includes first and second side walls with first and second lips extending perpendicularly from said walls, respectively. The first and second lips partially enclose an interior of the channel with the second lip extending further than the first lip. The lips are separated by an elongated slot having a width less than the thickness of the attachment insert. The first lip has a beveled edge angled towards the interior and the second lip has a beveled edge angled away from the interior. The insert is dimensioned to fit in the channel.

### FIELD OF THE INVENTION

The invention relates generally to roller tubes for roller blinds

### BACKGROUND OF THE INVENTION

Roller blinds are a popular type of window covering used to control the passage of light through a window. Roller blinds generally consist of an elongated rectangular fabric blind wrapped around a roller tube which is used to control the raising and lowering of the blind. The fabric sheet forming the fabric blind can be attached to the roller tube by simply adhering one end of the fabric sheet to the roller tube by means of adhesive tape. While this arrangement works adequately for many applications, modern roller blinds often employ heavier fabric blinds or multilayered fabric blinds which require more accurate and secure attachment of the fabric blinds to the roller tube.

To ensure accurate placement and mounting of the fabric sheet (blind) to the roller tube, the roller tube is generally provided with an elongated groove on its surface which extends along the entire length of the roller tube. The slot generally consists of a cavity which opens to the outside by a narrow elongated opening. One end of the fabric sheet is mounted to the groove via an elongated attachment member mounted to the end of the fabric sheet. The attachment member generally consists of an elongated member having a surface which is adhered to one end of the fabric by means of a strong adhesive. The attachment member is then inserted into the slot cavity through an open end of the slot positioned at an end of the roller tube with the fabric sheet manipulated to pass through the narrow elongated opening. The elongated opening, being much smaller than the elongated attachment member, prevents the attachment member from coming out of the slot, even when force is applied to the fabric.

In order to make it easier to mount the fabric to the roller tube, it is possible to form the attachment member as a flat elongated member having opposite sides and a thickness. One end of the fabric is adhered to one side of the flat member by means of a strong adhesive. If the thickness of the flat member is slightly less than the diameter of the elongated opening in the slot, then the flat member can be slide into the slot through the elongated opening. This makes it quicker to attach the fabric sheet to the roller tube, but there is a chance that the attachment member may slip out of the slot. To minimize this chance, it is possible to make the cavity in the slot only slightly larger than the attachment member; however, this decreases the ease of inserting the attachment member into the slot. What is required is a configuration of slot, elongated opening, cavity and attachment member shape which makes it possible to quickly and easily insert the attachment member into the slot while preventing the attachment member from accidentally dislodging from the slot.

### SUMMARY OF THE INVENTION

In accordance with one aspect of the present invention, there is provided a roller tube for attaching to a fabric sheet. The roller tube has a tubular wall having opposite ends with a channel running longitudinally in an exterior surface of the tubular wall and configured to receive an attachment insert for the fabric sheet. The attachment insert consists of an elongated flat member having opposite ends, opposite sides, a thickness defined by the opposite sides, opposite side edges and a width defined by the opposite side edges. The channel includes first and second side walls that extend from an interior portion of said tubular wall toward said exterior surface. First and second lips extend perpendicularly from the first and second walls along the exterior surface of said tubular wall, respectively. The first and second lips partially enclose an interior of the channel with the second lip extending further along the exterior surface than the first lip. The first and second lips are separated by an elongated slot having a width less than the thickness of the attachment insert. The first lip having a beveled edge angled towards the interior of the channel, the second lip having a beveled edge angled away from the interior of the channel; The width of the insert member being greater than the width of the elongated slot and less than a distance separating the first and second walls.

In accordance with another aspect of the present invention, there is provided a method for attaching a sheet material to a roller tube. The method includes the step of providing a roller tube having opposite ends and including a channel running longitudinally in an exterior surface of said tubular wall, said channel configured to receive an attachment insert for the sheet material. The attachment insert includes an elongated flat member having opposite ends, opposite sides, opposite first and second side edges, a thickness defined by the opposite sides and a width defined by the opposite first and second side edges. The method further includes the step of providing said channel with first and second side walls that extend from an interior portion of said tubular wall towards said exterior surface. Providing said channel with first and second lips extending perpendicularly from the first and second walls along the exterior surface of said tubular wall, respectively, said first and second lips partially enclosing an interior of the channel, the second lip extending further along the exterior surface than the first lip, said first and second lips being separated by an elongated slot having a width less than the thickness of the attachment insert. Providing the first lip with a beveled edge angled towards the interior of the channel and the second lip has a beveled edge angled away from the interior of the channel. The width of the attachment insert is greater than the width of the elongated slot and less than a distance separating the first and second walls. An edge of the sheet material is then adhered to one side of the attachment insert with said edge of the sheet material positioned adjacent the first side edge of the insert and then with the sheet material wrapped around the second side edge of the attachment insert, the attachment insert is inserted into the channel by inserting the second side edge of the attachment insert into the channel with the edge of the sheet material oriented towards the channel, then inserting the second side edge into the channel to fully insert the attachment insert into the channel.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a side view of a portion of a roller tube made in accordance with the present invention showing the attachment insert having a portion of a fabric sheet adhered thereto being inserted into the elongated channel portion of the roller tube.

FIG. 2 is a side view of the portion of the roller tube shown in FIG. 1 showing the attachment insert partially inserted into the elongated channel.

FIG. 3 is a side view of the portion of the roller tube shown in FIG. 1 showing the attachment insert fully inserted into the elongated channel.

FIG. 4 is an end view of a roller tube made in accordance with the present invention.

FIG. 5 is a perspective view of a roller tube made in accordance with the present invention.

FIG. 6 is a side view of the channel portion of the present invention showing the angular relationship of the various components thereof.

FIG. 7 is a perspective view of an attachment insert made in accordance to the present invention and a fabric sheet for mounting to the roller tube made in accordance with the present invention with the aid of the attachment insert shown.

In the drawings like characters of reference indicate corresponding parts in the different figures.

### DETAILED DESCRIPTION OF THE INVENTION

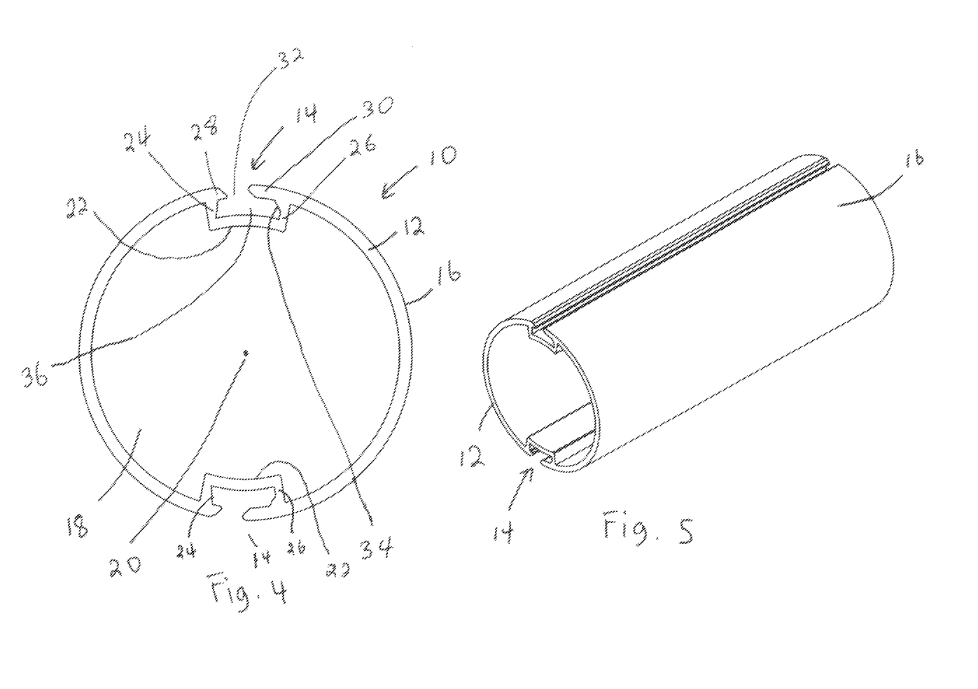

Referring to FIGS. 4 and 5, a roller tube made in accordance with the present invention consists of an elongated cylindrical tube 10 preferably made of extruded aluminum. Tube 10 has wall 12, an exterior surface 16, and interior 18, a longitudinal axis 20 and at least one elongated channel 14 formed in wall 12. Wall 12 extends inwardly towards axis 20 where channels 14 are formed such that each channel has a floor 22, a first wall 24 and a second wall 26 which extend from floor 22 towards exterior surface 16. First lip 28 extends from first wall 24 along exterior surface 16 and second lip 30 extends from second wall 26 along exterior surface 16 such that the first and second lips are opposed and separated by an elongated slot 32 and such that lips 28 and 30 partially enclose an interior 36 of channel 14.

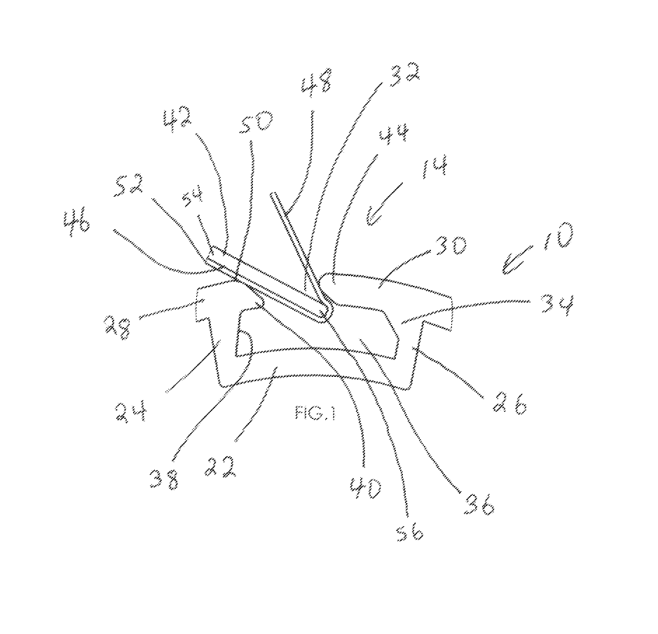

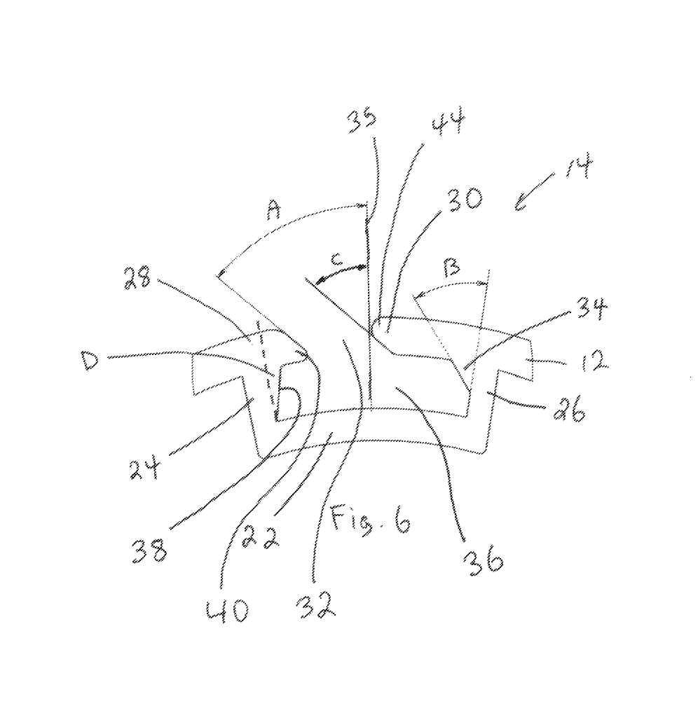

Referring now to FIG. 6, opposing lips 28 and 30 are beveled. First lip 28 has a beveled edge 40 which is set at angle A from ray 35 which extends perpendicularly from floor 22 of channel 14. Angle A is set to be beveled towards the interior 36 of channel 14, meaning that the tip of edge 40 is oriented towards interior 36 as illustrated. Preferably angle A is set at less than 90°. Angle A is preferably between about 45° to about 50°. Second lip 30 is has a beveled edge 44 which is set at angle C from ray 35. Angle C is set such that edge 44 is beveled away from interior 36. Angle C is also less than 90° and is preferably between about 45° to about 50°. As shall be discussed below, beveled edges 40 and 44 help ensure that attachment insert (item 42 in FIGS. 1 to 3) is guided into the right orientation as it is inserted into interior 36.

Lip 30 extends further from second wall 26 than does lip 28. Chamfer 34 is formed at the intersection of wall 26 and lip 30. Chamfer 34 is set at angle B from wall 26 and is less than 90°. Preferably, angle B is set at about 45°. Wall 24 has a face 38 which is inclined towards interior 36 at angle D. Angle D is preferably less than 45°.

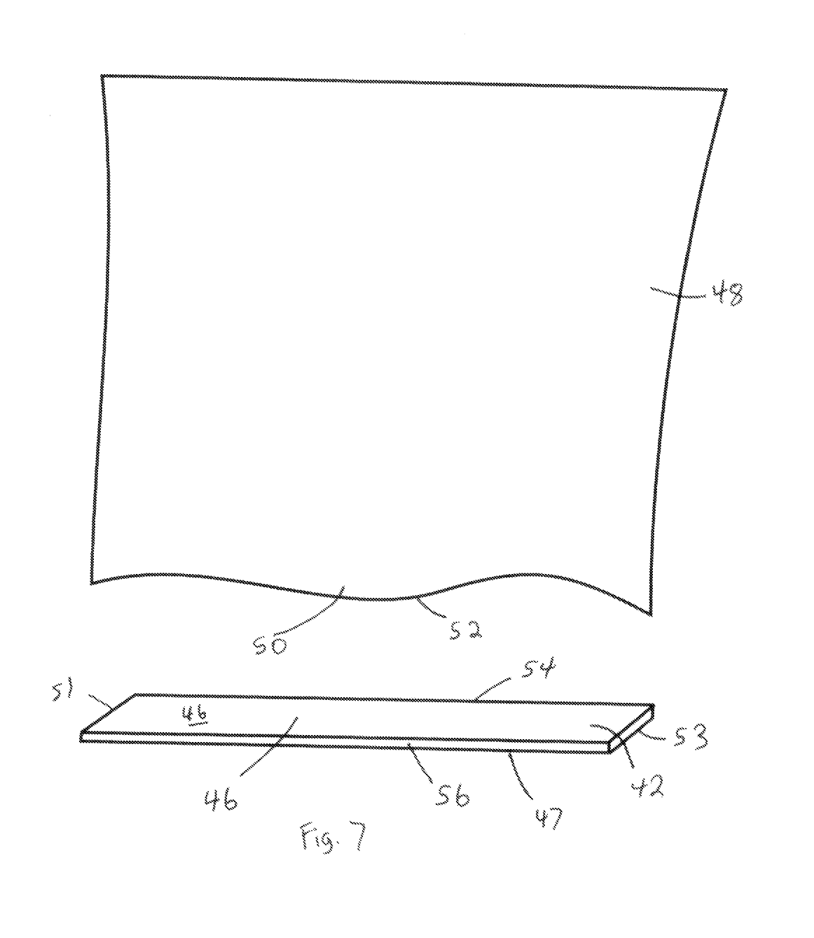

Referring now to FIG. 7, the roller tube made in accordance with the present invention is used to mount and roll up a fabric sheet. Fabric sheet 48 consists of a flexible web of either woven or non woven material. Fabric sheet 48 has a lower edge 52 with a peripheral portion 50 extending along edge 52. Attachment insert 42 is provided to help mount the fabric sheet to the roller tube. Attachment insert 42 is an elongated member having opposite ends 51 and 53, opposite sides 46 and 47 and opposite side edges 56 and 54. Fabric sheet 48 can be mounted to attachment insert 42 by first applying an adhesive (not shown) along surface 46 of the attachment insert and then overlapping peripheral portion 50 of the sheet over surface 46 and then pressing the peripheral portion of the sheet onto the attachment insert so as to adhere the sheet to the attachment insert. Edge 52 of the sheet should be aligned closely with edge 54 of the attachment insert to ensure that the entire surface 46 is adhered to sheet 48 and to ensure that there are no unsightly ripples or ridges formed on the fabric sheet. After the adhesive is cured, the attachment insert can be used to mount the fabric sheet to the roller tube, as discussed below.

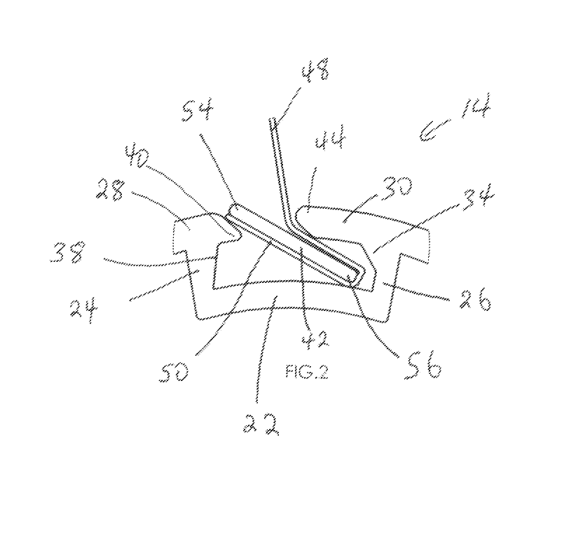

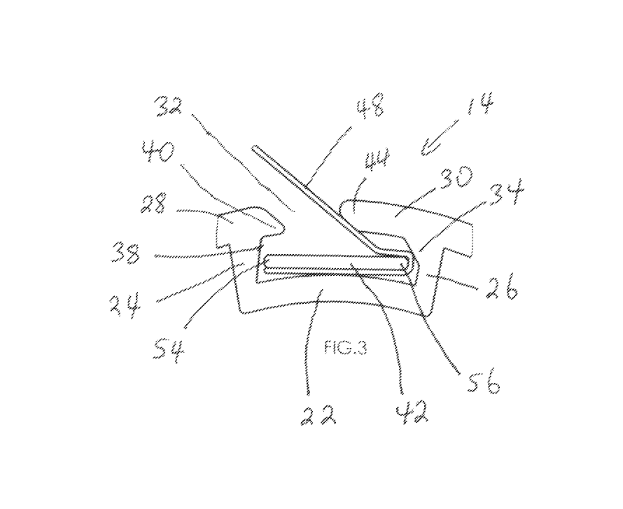

Referring now to FIG. 1, attachment insert 42 with sheet 48 adhered thereto can be mounted to roller tube 10 by inserting the attachment insert 42 through gap 32 and into interior 36 of channel 14. Sheet 48 is partially wrapped around edge 56 of attachment insert 42 and the attachment insert is oriented such that peripheral portion 50 of the sheet is positioned between the roller tube and the attachment insert. Edge 56 is then forced through gap 32. Beveled edges 40 and 44 help to guide edge 56 as the attachment insert is passed through gap 32. The beveled edges also help to ensure that edge 56 is oriented towards wall 26 and under lip 30 as seen in FIG. 2. When fully inserted, as shown in FIG. 3, the attachment insert lies between walls 24 and 26 with edge 54 oriented towards included surface 38 of wall 24 and edge 56 oriented towards wall 26. Since edge 56 extends well below lip 30, attachment insert 42 can only be dislodged from interior 36 of channel 14 by lifting end 54 upwards which requires end 56 to be moved towards wall 26. However, chamfer 34 ensures that if edge 56 is lifted, it will bear against the chamfer causing edge 56 to move away from wall 26 and edge 54 to remain trapped under lip 28. Furthermore, face 38, being inclined towards wall 26 further ensures that as edge 54 is lifted upwardly the edge will bear against the inclined wall, thereby resisting the edge being lifted. Since fabric 48 is partially wrapped around end 56, pulling on the fabric causes edge 56 to lift, trapping the attachment insert within interior 36. As a result of the position of chamfer 34 and inclined surface 38, once attachment insert 42 is positioned inside channel 14, it is virtually impossible to remove it by pulling on fabric sheet 48.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A roller tube comprising:
a. a tubular wall having a longitudinal axis and including a first end and a second end opposite said first end;
b. A channel running longitudinally in an exterior surface of said tubular wall and configured to receive an attachment insert for sheet material;
c. The attachment insert comprising an elongated flat member having opposite ends, opposite sides, a thickness defined by the opposite sides, opposite side edges and a width defined by the opposite side edges;
d. Wherein said channel comprises first and second side walls that extend from an interior portion of said tubular wall toward said exterior surface;
e. First and second lips extending perpendicularly from the first and second walls along the exterior surface of said tubular wall, respectively, said first and second lips partially enclosing an interior of the channel, the second lip extending further along the exterior surface than the first lip, said first and second lips being separated by an elongated slot having a width less than the thickness of the attachment insert;
f. The first lip having a beveled edge angled towards the interior of the channel, the second lip having a beveled edge angled away from the interior of the channel;
g. A chamfer formed at the intersection of the second wall and the second lip, and
h. The width of the insert member being greater than the width of the elongated slot and less than a distance separating the first and second walls.

2. A roller tube for attaching to a fabric sheet, the roller tube comprising:
a. a tubular wall having opposite ends;
b. A channel running longitudinally in an exterior surface of said tubular wall and configured to receive an attachment insert for the fabric sheet;
c. The attachment insert comprising an elongated flat member having opposite ends, opposite sides, a thickness defined by the opposite sides, opposite side edges and a width defined by the opposite side edges;
d. Wherein said channel comprises first and second side walls that extend from an interior portion of said tubular wall toward said exterior surface;
e. First and second lips extending perpendicularly from the first and second walls along the exterior surface of said tubular wall, respectively, said first and second lips partially enclosing an interior of the channel, the second lip extending further along the exterior surface than the first lip, said first and second lips being separated by an elongated slot having a width less than the thickness of the attachment insert;
f. The first lip having a beveled edge angled towards the interior of the channel, the second lip having a beveled edge angled away from the interior of the channel;
g. The width of the insert member being greater than the width of the elongated slot and less than a distance separating the first and second walls.

3. The roller tube defined in claim 2 wherein the second wall has a chamfer where the second wall meets the second lip.

4. The roller tube defined in claim 3 wherein the first wall is inclined towards the second wall as it extends from the interior portion of the tubular wall towards the exterior surface.

5. The roller tube defined in claim 1 wherein the first wall is inclined towards the second wall as it extends from the interior portion of the tubular wall towards the exterior surface.

6. A method for attaching a sheet material to a roller tube, comprising: providing a roller tube having opposite ends and including a channel running longitudinally in an exterior surface of said tubular wall, said channel configured to receive an attachment insert for the sheet material; said attachment insert comprising an elongated flat member having opposite ends, opposite sides, opposite first and second side edges, a thickness defined by the opposite sides and a width defined by the opposite first and second side edges; providing said channel with first and second side walls that extend from an interior portion of said tubular wall towards said exterior surface; providing said channel with first and second lips extending perpendicularly from the first and second walls along the exterior surface of said tubular wall, respectively, said first and second lips partially enclosing an interior of the channel, the second lip extending further along the exterior surface than the first lip, said first and second lips being separated by an elongated slot having a width less than the thickness of the attachment insert; providing the first lip with a beveled edge angled towards the interior of the channel and the second lip has a beveled edge angled away from the interior of the channel; wherein the width of the insert member is greater than the width of the elongated slot and less than a distance separating the first and second walls; adhering an edge of the sheet material to one side of the attachment insert with said edge of the sheet material positioned adjacent first side edge of the insert and then with the sheet material wrapped around the second side edge of the attachment insert, inserting the second side edge of the attachment insert into the channel with the edge of the sheet material oriented towards the channel, then inserting the second side edge into the channel to fully insert the attachment insert into the channel.
